(19) United States
(12) Patent Application Publication
(10) Pub. No.: US 2004/0152048 A1
(43) Pub. Date: Aug. 5, 2004

(54) Temporary attachment for jaw implants

(76) Inventor: Wolfgang Dinkelacker, Sindelfingen (DE)

Correspondence Address: KUDIRKA & JOBSE, LLP, ONE STATE STREET, SUITE 800, BOSTON, MA, 02109, US

(21) Appl. No.: 10/764,219

(22) Filed: Jan. 23, 2004

(30) Foreign Application Priority Data
Jan. 25, 2003 (EP) 03 001 688.5

(51) Int. Cl. A61C 8/00

(52) U.S. Cl. 433/173; 433/169

(57) ABSTRACT

A temporary attachment for a jaw implant has a molded piece made of an elastic material situated between a base and a head. The molded piece is deformable under the influence of a screw and this deformation is transferred to the surrounding tissue. By repeated tightening of the screw during a healing phase, the gingival tissue can be widened without resulting in tissue injury. Due to the shape of the base or the head, a predetermined deformation can be produced, and may be radially asymmetric. The direction of deformation can also be selected by varying the angular position of the base or the head with respect to the longitudinal axis of the implant.

### FIELD OF THE INVENTION

This invention relates to a temporary attachment for jaw implants, in which the temporary attachment is attached to the implant by means of a screw after the implant has been inserted into the jaw bone.

### BACKGROUND OF THE INVENTION

In the field of jaw implants, it is known that after the implant has been inserted into the jaw bone, the head of the implant is covered by a temporary attachment during the healing phase to protect the head of the implant and prevent food residues and pathogens from being introduced. Instead of this one-step method, it is also possible to proceed in two steps by first suturing the skin over the cover in the area of the implant wound after the surgery so that the cover is not perceived by the patient as an interfering foreign body during the healing process.

French Patent FR-A 2720624 describes a roof-shaped healing cap which is placed on the implant after surgery. Disk-shaped projections on the lower side of the cap, engaging in corresponding recesses in the implant body, are used for this purpose. U.S. Pat. No. 5,636,989 discloses a button-shaped healing cap the lower side of which is adapted to the shape of the implant head and which engages with a wedge-shaped extension in a conical bore in the implant. In another known embodiment, an installation cap is attached to the head of a dental implant by means of a screw in a central threaded bore which serves to attach a carrying body for a dental prosthesis after removing the cap (U.S. Pat. No. 5,209,659). These known temporary implant attachments are limited to protection of the implant after it is implanted.

It is also known that in the case of an adjustable dental implant, the carrying body for the dental prosthesis can be adjustably arranged on the implant so that after insertion of the implant, a correction or alignment of the carrying body is possible in order to allow a subsequent change in the seating of the dental prosthesis (U.S. Pat. No. 5,195,891). This implant has a two-part anchor as the carrying body, its lower part being attached to the implant body by a screw connection and its upper part forming an angle with the implant axis and being rotatably arranged on the lower part. A cap made of nylon is placed on the upper part of the anchor by a snap connection and serves as the base for the dental prosthesis. Alignment of the position of the dental prosthesis is possible by turning the upper part of the anchor.

Accordingly, there is a need for a temporary attachment on a jaw implant that not only protects the implant but also permits improved adaptation of the soft tissue above the implant according to the superstructure to be attached to the implant.

### SUMMARY OF THE INVENTION

In accordance with the principles of the invention, a temporary implant attachment has a molded piece of elastic material situated between a base part and a head part. The elastic material can be deformed under the influence of a fastening screw and the deformation is transferred to the surrounding tissue so that the channel in the gingiva above the inserted implant can be preshaped during the healing phase. In this way the soft tissue can be adapted to the shape of the superstructure to be joined to the implant during the healing process. Thus, the channel in the soft tissue can be widened by repeated tightening of the fastening screw without causing any tissue damage. The surgical procedure required for shaping the superstructure can thus be minimized, which also reduces the risk of inflammation and infection.

In one embodiment of the invention, the deformation of the molded piece can be controlled by profiling the base part, the head part, or both parts of the implant attachment. For example, by using asymmetrical profiling, an out-of-round or unilateral deformation of the molded part can be accomplished. In addition, the base part, the head part or both are arranged adjustably in their angular position with respect to the longitudinal axis of the implant, so the direction of the deformation is selectable. Preshaping of the soft tissue may thus take place in such a manner that the advantageous effects are achieved in particular when corrections or adjustments in the seating of the superstructure on the implant are necessary.

### BRIEF DESCRIPTION OF THE DRAWINGS

The above and further advantages of the invention may be better understood by referring to the following description in conjunction with the accompanying drawings in which:

FIG. 1 is a cross-sectional diagram of an embodiment of the temporary implant attachment according to this invention with a profiled head part and base part;

FIG. 2 is a cross-sectional diagram of the temporary implant attachment according to FIG. 1 in a compressed state;

FIG. 3 is a cross-sectional diagram of another embodiment of the inventive temporary implant attachment with a profiled base part and a planar head part;

FIG. 4 is a cross-sectional diagram of the temporary implant attachment according to FIG. 3 in a compressed state;

FIG. 5 is a top view of the temporary implant attachment according to FIG. 3 in a compressed state according to FIG. 4;

FIG. 6 is a cross-sectional diagram of another embodiment of the inventive temporary implant attachment;

FIG. 7 is a cross-sectional diagram of another embodiment of the inventive temporary implant attachment with a rotatable head part;

FIG. 8 is a top view of the temporary implant attachment according to FIG. 7;

FIG. 9 is a cross-sectional diagram of the temporary implant attachment from FIG. 7 in a 90-degree rotated position; and

FIG. 10 is a top view of the temporary implant attachment according to FIG. 6 in the position shown in FIG. 9.

### DETAILED DESCRIPTION

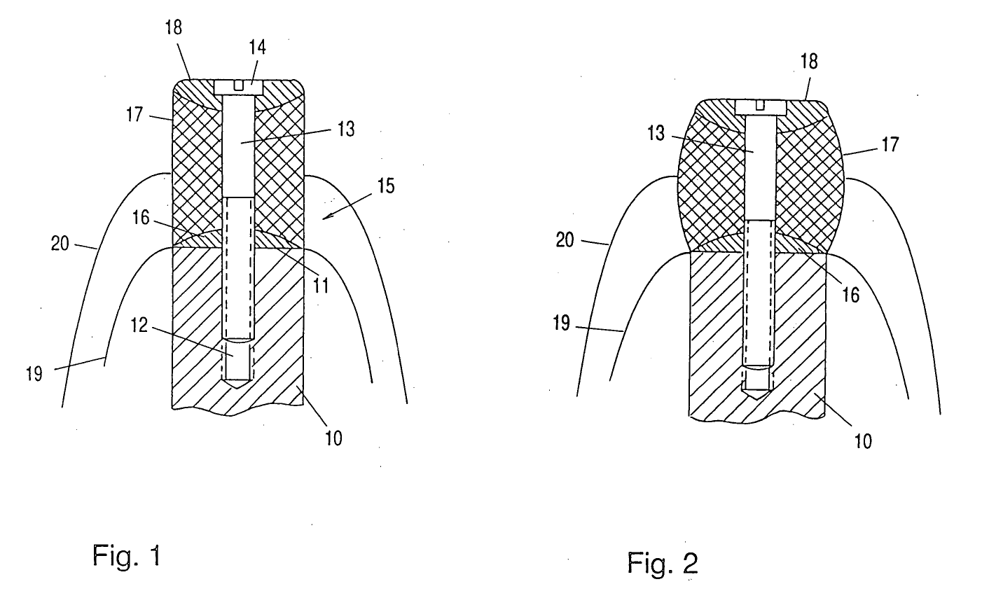

FIG. 1 shows a partial section of a rotationally symmetrical jaw implant 10 with a planar implant head 11. The implant 10 is preferably made of titanium or a titanium alloy or some other suitable material such as ceramic or porcelain. To anchor the implant in the jaw, a system of grooves and cylindrical gradations may be provided on the implant circumference, as disclosed in European Patent EP-A 1013236. Instead of that, the implant body may be designed as a screw. The implant 10 is designed to be cylindrical in the embodiment depicted in FIG. 1 and has a central threaded bore 12 in the direction of its longitudinal axis so that a screw 13 can engage in it to fasten a superstructure (not shown), such as a crown.

After insertion of the implant into the jawbone, a healing phase of a few months begins. During this period of time, a temporary attachment 15 is bonded to the implant 10, to which end the screw 13 is used, screwed into the threaded bore 12. The temporary attachment 15 consists of a base part 16, a molded piece 17 and a head part 18. These parts have a diameter that is adapted to the diameter of the implant 10 and they also have central bores to accommodate the screw 13.

The base part 16 is a planar convex plate which sits with its planar surface on the implant head 11 and its convex surface is in contact with the molded piece 17. When the temporary attachment 15 is used in combination with an implant comprising an implant head in a profile such as unilateral or bilateral slopes, hexagonal projections or the like, the base part is adapted to this profile on the side facing the implant.

Likewise, the head part 18 is designed as a planar convex plate whose convex surface is in contact with the molded piece 17 and into whose planar top side is inserted a flat head 14 of the screw 13. The base part 16 and the head part 18 are preferably made of the same material as the implant 10.

The molded piece 17 is between the base part 16 and the head part 18 and is preferably adapted to the convex surfaces of these parts by concave recesses. It is made of a biocompatible elastic material, preferably silicone, which can be compressed under axial pressure and thereby enlarges its circumference.

After the implant 10 has been inserted into the jawbone 19, the temporary attachment 15 is attached to the implant with the help of the screw 13 which is tightened to the extent that the parts 16, 17, 18 are in contact with one another and the base plate 16 is in contact with the implant head 11. Then the gingiva 20 is applied to the circumference of the temporary attachment 15 and sutured there. The upper edge of gingiva 20 is preferably in the center of the height of the molded piece 15. Thus, the center part of the molded piece which experiences the greatest elongation is situated in the area of the through-opening of the gingiva to accommodate the superstructure.

During the subsequent wound-healing process, the gingival tissue is in close contact with the molded piece 15. The healing phase lasts a few months. Toward the end of this time, the screw 13 is tightened repeatedly, e.g., at weekly intervals, to the extent that there is an widening of the tissue surrounding the molded piece due to radial expansion of the molded piece 17 without resulting in tears in the gingiva 20. Under the influence of the convex surfaces of the base plate 16 and the head plate 18 the molded piece 17 is compressed, whereupon its circumference is enlarged like a barrel as shown in FIG. 2.

Under the influence of this deformation, the hole above the implant 10 in the gingiva 19 is enlarged and adapted to the diameter of the superstructure which is placed on the implant 10 after the end of the healing phase and after the temporary attachment 15 has first been removed. This requires only minor manipulation of the gingiva, because the gingival opening above the implant 10 has already been adapted to the dimensions of the superstructure due to the prior expansion steps. Threaded bore 12 is used to attach the superstructure to the implant. FIG. 2 shows the condition of the molded piece 17 at the end of the healing phase.

As an alternative, the temporary attachment 15 may also be used only after the implant 10 has healed in place. In this case, after the surgery, the inserted implant is sealed with a traditional healing cap and the gingiva is sutured. After the implant has healed in place, the gingiva is reopened and the healing cap is removed. Then the temporary attachment 15 is attached to the implant in the manner described here. The gingiva 20 is applied to the circumference of the temporary attachment 15 and sutured to the extent that only the screw head 12 remains free. After a wound-healing phase, the screw 13 is reset in the manner described above to expand the gingival opening for attachment of the superstructure.

If the temporary attachment 15 is used in combination with an implant which includes an implant head in a profile such as unilateral or bilateral slopes, hexagonal projections or the like, the base part is adapted to this profile on the side facing the implant. An example of such an embodiment is described below on the basis of FIGS. 3-5. FIG. 3 shows the partial cross-sectional view of a rotationally symmetrical jaw implant 30 with an implant head 31 which has a profile in the form of opposing slopes 32, 33 of the type depicted in European Patent EP-A 0868889. The implant 30 is again preferably made of titanium or a titanium alloy and has a system (not shown) of grooves and cylindrical gradations on its circumference, as disclosed in European Patent EP-A 1013236, or is designed as a screw in a known way. The implant 30 is designed to be cylindrical and has a central threaded bore 34 in the direction of its longitudinal axis for attaching a superstructure.

After insertion of the implant into the jawbone, a healing phase of a few months begins. During this period of time, a temporary attachment 35 is attached to the implant using a screw 36 which is screwed into the threaded bore 34. The temporary attachment 35 consists of a base part 37, a molded piece 38 and a screw head 39. These parts have diameters adapted to the diameter of the implant 30. The base part 36 and the molded piece 37 have central bores to accommodate the screw 36.

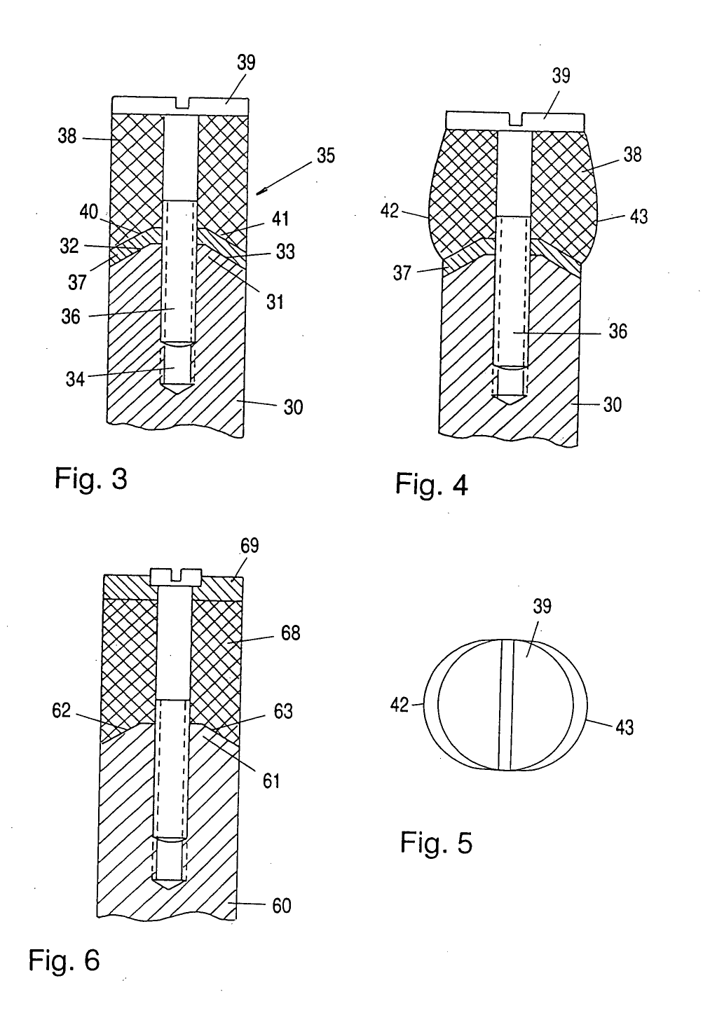

The molded piece 38 is made of a biocompatible elastic material like the molded piece 17 of FIG. 1. The base part 37 is a plate which is adapted to the profile of the implant head 31 and rests on it, secured against rotation. In the exemplary embodiment of FIG. 3, the implant head 31 has a wedge-shaped profile which is determined by slopes 32, 33 that are exposed on the buccal side and on the lingual side. The surface of the base part 37 facing the molded piece has a corresponding wedge-shaped profile with flanks 40, 41. FIG. 3 shows the temporary attachment 35 in a state in which the screw 36 has been tightened only to the extent that the parts 31, 37, 38 and 39 are in contact with one another. By further tightening of the screw 36, the molded piece 38 is compressed and thereby deformed so that bulges 42, 43 are formed on its circumference (FIGS. 4 and 5). The flanks 40, 41 generate a pressure on the molded piece 38 acting away from the implant axis toward the outside. On the other hand, the plane-parallel screw head 39 generates an axial pressure on the molded piece 38 so that it assumes a pear-shaped profile as depicted in FIG. 4. The gingiva surrounding the temporary attachment is thus widened only toward the buccal side and the lingual side to accommodate a suitably shaped superstructure.

As shown by the embodiment according to FIG. 6, in the case of an implant 60 having an implant head 61 which has a profile of the type described in conjunction with FIG. 3, sloped on both sides, the implant head 61 may assume the function of the base part. The effect of the slopes 62, 63 of the implant head 61 on a molded piece 68 corresponds here to the effect of the flanks 40, 41 on the molded piece 38 in the exemplary embodiment according to FIGS. 3 through 5. Instead of the screw head, which fulfills the function of the head part there, the head part in the embodiment according to FIG. 6 is a plane-parallel plate 69.

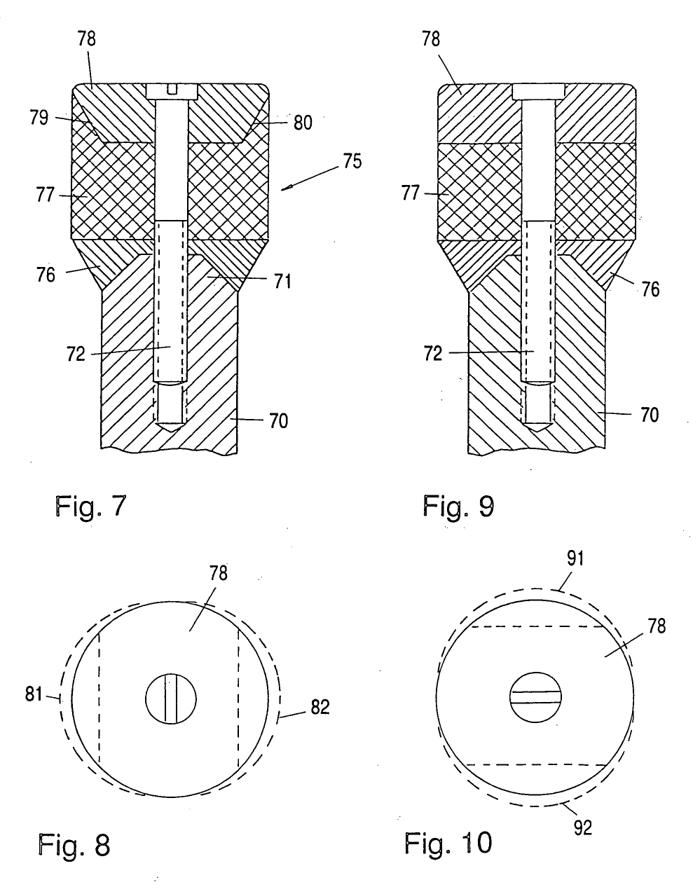

The arrangement according to this invention may be designed so that the two-sided expansion of the gingiva takes place in the mesial and distal directions. FIG. 7 shows a cylindrical implant 70 with an implant head 71 which has a profile of the type depicted in conjunction with FIG. 3 that is sloping on two sides. A temporary attachment 75 is connected to the implant 70 by means of a screw 72. The temporary attachment 75 consists of a base part 76, a molded piece 77 and a head part 78 which has central bores to accommodate the screw 72. The diameter of the parts 76, 77 and 78 is adapted to the size of the superstructure to be placed on the implant and is greater than the diameter of the implant 70. The molded piece 77 is made of a biocompatible elastic material like the molded piece 17 in FIG. 1. The base part 76 is a profiled plate which is shaped on its lower side according to the profile of the implant head 71 and rests on the latter. The top side of the base part is designed to be flat. The molded piece 77 rests on it. Likewise the head part 78 is designed as a profiled plate into whose planar top side the head of the screw 72 is countersunk. The lower side of the head part 78 facing the molded piece has slopes 79, 80 which taper downward and protrude into a suitably shaped recess in the molded part 77.

When the screw 72 is tightened in the manner described above with reference to FIGS. 1 and 3, lateral bulges 81, 82 are formed on the molded piece 77 under the influence of the slopes 79, 80 (FIG. 8). The bulges 81, 82 may be oriented in the direction of the buccal side and in the direction of the lingual side, as in the exemplary embodiment in FIG. 3. By turning the head part 78 by 90° as shown in FIG. 9, it is possible to achieve the result that with appropriate tightening of the screw 72, lateral bulges 91, 92 of the molded piece 77 in the mesial and distal directions are obtained (FIG. 10). The temporary attachment 75 may thus be adapted to the position of the implant in the jawbone and the type of superstructure to be joined with the implant by changing the position of the head part 78.

In another modification of the exemplary embodiment according to FIGS. 6-8, the head part 78 may be designed to be asymmetrical by providing only one slope on the underside of the head part 78 instead of two slopes 79, 80 while the other side is flat toward the circumference and thus runs parallel to the base part 76 in this area. In such an embodiment, the molded piece 77 undergoes asymmetrical deformation when the screw 72 is tightened accordingly. Instead of bilateral bulges 81, 82 or 91, 92, only one bulge 81 or 82 and/or 91, 92 is obtained, each being aligned on the buccal side or the lingual side and/or the mesial side or the distal side, depending on the position of the head part 78. In this way, the inventive temporary attachment may be used even when there is essentially to be an expansion of the gingiva toward a certain side.

In the exemplary embodiments of this invention described with reference to FIGS. 1-5 and 7-10, the arrangement of the base part and the molded piece may be made so that the elastic molded piece is fixedly connected to the rigid base part or to the rigid head part or to both to form a module. This may be accomplished, for example, by means of an adhesive bond or by thermal fusion. The module is adapted to the profile of the implant head, as described above with regard to the base part. The means of securing to prevent rotation which is performed due to the profile of the implant head is also effective for the molded piece over the base part.

A temporary attachment according to the type of temporary attachments 15, 35, 75 is preferably used in conjunction with dental implants, but it is not limited to these and instead may also be used with other implants which require a breakthrough through soft tissue to the outside for subsequent application of other devices and which is to be preformed according to the shape of these devices during the healing phase.

Although this invention has been described on the basis of preferred embodiments, modifications and other embodiments may be implemented without going beyond the scope of this invention as defined in the claims.

What is claimed is:

1. A temporary attachment for jaw implants, the temporary attachment being attached to a jaw implant by means of a screw after the implant has been inserted into a jawbone and comprising:
a base;
a head;
a molded piece made of a biocompatible and elastic material located between the base and the head, said elastic material being deformable under the action of the screw and situated in order to transfer the resulting deformation to surrounding jaw tissue.

2. The temporary attachment of claim 1, wherein the jaw implant has a head with a shape and wherein the base has a first side shaped to fit closely to the implant head shape, has a second side in contact with the molded piece and is attached to the implant head by the screw.

3. The temporary attachment of claim 2, wherein the second side of the base has a shape profile that predetermines the type of deformation of the molded piece in the area of the base.

4. The temporary attachment of claim 1, wherein the head has a side in contact with the molded piece, the head side having a shape profile which predetermines the type of deformation of the molded piece in the area of the head.

5. The temporary attachment of claim 4, wherein the base has a side in contact with the molded piece and wherein the base side and the head side each have a convex shape profile which results in a barrel-shaped deformation of the molded piece under action of the screw.

6. The temporary attachment of claim 4, wherein the head side has a shape profile which tapers toward the molded piece and predetermines a deformation of the molded piece in the area of the head.

7. The temporary attachment of claim 4 wherein the base has a side in contact with the molded piece and wherein one of the base side and the head side has a radially asymmetric shape profile causing a radially asymmetric deformation of the molded piece extending in a predetermined radial direction.

8. The temporary attachment of claim 7 wherein the predetermined radial direction of deformation can be selected by rotating one of the base and the head around a longitudinal axis of the implant.

9. The temporary attachment of claim 1, wherein the screw has a head and wherein the attachment head comprises the screw head.

10. The temporary attachment of claim 1 wherein the head comprises a plate having a bore therein through which passes the screw so that the plate is drawn against the molded piece by the action of the screw.

11. The temporary attachment of claim 1 wherein the molded piece has a cylindrical shape.

12. The temporary attachment of claim 1 wherein the molded piece has a longitudinal height at least equal to a thickness of gingival tissue layer over the jawbone.

13. The temporary attachment of claim 1 wherein the molded piece is fabricated of silicone material.

14. The temporary attachment of claim 1 wherein the implant has a head that contacts the molded piece and wherein the base comprises the implant head.

15. The temporary attachment of claim 1, wherein the implant has a head with a shape that contacts the base and wherein the base is shaped to prevent rotation of the base with respect to the implant head.

16. The temporary attachment of claim 1, wherein at least one of the base and the head is attached to the molded piece.

17. The temporary attachment of claim 1, wherein the screw threads into a threaded bore in the jaw implant wherein the threaded bore is used to fasten a superstructure to the implant.
